(19) United States
(12) Patent Application Publication
(10) Pub. No.: US 2007/0065226 A1
(43) Pub. Date: Mar. 22, 2007

(54) Angle adjustable shank for large-size umbrella

(76) Inventor: Jin-Sheng Lai, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/231,037

(22) Filed: Sep. 20, 2005

(51) Int. Cl. F16B 7/10

(52) U.S. Cl. 403/109.1

(57) ABSTRACT

A shank for a large-size umbrella includes a base tube, a rotation tube, a plurality of rotation balls, and a rotation control member. When the rotation balls are rotated to a determined position, the limit post of the contact face of the rotation tube is rotated into and limited in the limit hole of the rotation control member so as to limit rotation of the rotation tube. Thus, the rotation of the rotation tube is limited by the rotation control member so that the rotation tube will not be rotated excessively, thereby preventing the control cord from being tangled.

### BACKGROUND OF THE INVENTION

1. Field of the Invention

The present invention relates to a shank for a large-size umbrella, and more particularly to an angle adjustable shank for a large-size umbrella.

2. Description of the Related Art

A conventional large-size umbrella comprises a shank, a canopy mounted on the upper end of the shank, a control cord extended through the shank and connected to the canopy, and a winding mechanism mounted in the shank for winding the control cord so as to expand the canopy. The umbrella is rotated according to the incident angle of the solar rays to provide a sunshade effect. When the umbrella is rotated, the control cord is driven by rotation of the umbrella. However, when the umbrella is not rotated in a determined direction, the control cord driven by rotation of the umbrella is easily tangled.

### SUMMARY OF THE INVENTION

In accordance with the present invention, there is provided a shank for a large-size umbrella, comprising a base tube having an upper end formed with a tapered contact face having a periphery formed with a plurality of positioning holes, a rotation tube having a lower end formed with a tapered contact face rotatably mounted on the contact face of the base tube and provided with a protruding limit post, a plurality of rotation balls detachably positioned in the positioning holes of the contact face of the base tube, and a rotation control member mounted between the base tube and the rotation tube and formed with at least one limit hole. Thus, when the rotation balls are rotated to a determined position, the limit post of the contact face of the rotation tube is rotated into and limited in the limit hole of the rotation control member.

The primary objective of the present invention is to provide an angle adjustable shank for a large-size umbrella.

Another objective of the present invention is to provide a shank for a large-size umbrella, wherein when the rotation balls are rotated to a determined position, the limit post of the contact face of the rotation tube is rotated into and limited in the limit hole of the rotation control member so as to limit rotation of the rotation tube.

A further objective of the present invention is to provide a shank for a large-size umbrella, wherein the rotation of the rotation tube is limited by the rotation control member so that the rotation tube will not be rotated excessively, thereby preventing the control cord from being tangled.

A further objective of the present invention is to provide a shank for a large-size umbrella, wherein the rotation tube is rotated in a determined direction, so that the shank is operated easily and conveniently, thereby facilitating a user operating the shank.

A further objective of the present invention is to provide a shank for a large-size umbrella, wherein the shank is assembled easily and rapidly, thereby facilitating assembly of the shank and decreasing costs of assembly.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a shank in accordance with the preferred embodiment of the present invention.

FIG. 2 is an exploded perspective view of the shank as shown in FIG. 1.

FIG. 3 is a bottom plan view of a rotation tube of the shank as shown in FIG. 2.

FIG. 4 is a top plan view of a rotation control member of the shank as shown in FIG. 2.

FIG. 5 is a plan cross-sectional view of the shank as shown in FIG. 1.

FIG. 6 is a schematic operational view of the shank as shown in FIG. 1 in use.

FIG. 7 is a perspective operational view of the shank for a large-size umbrella in accordance with the preferred embodiment of the present invention.

### DETAILED DESCRIPTION OF THE INVENTION

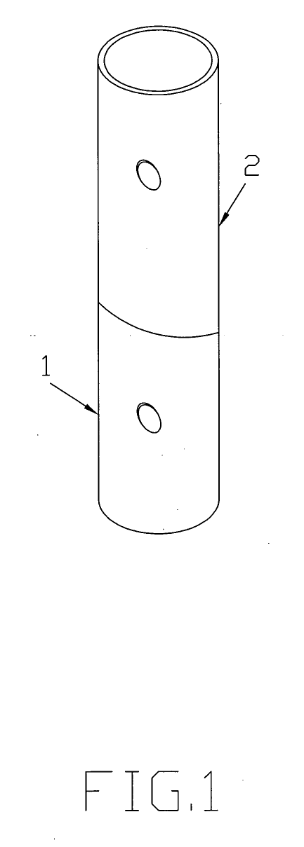

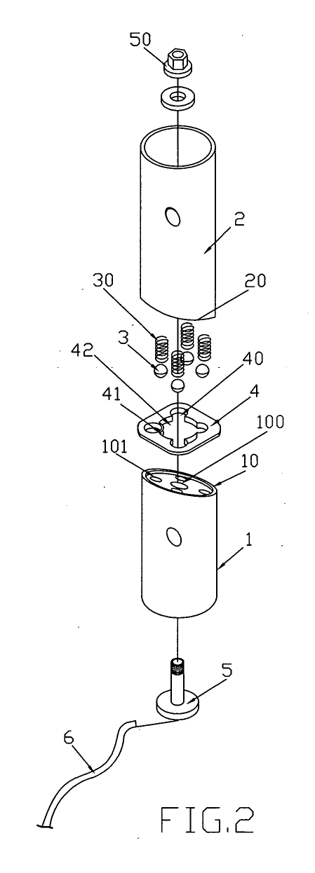

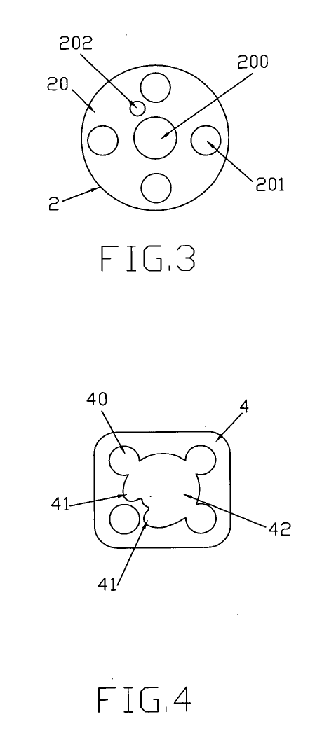

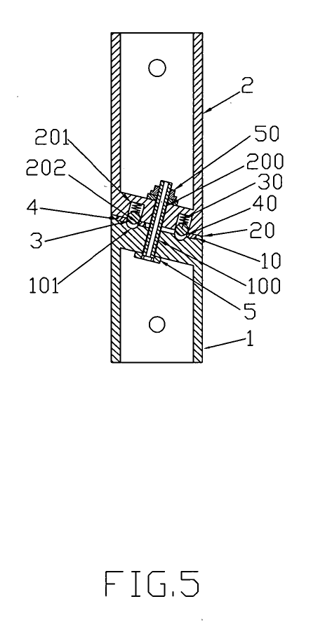

Referring to the drawings and initially to FIGS. 1-5, a shank for a large-size umbrella in accordance with the preferred embodiment of the present invention comprises a base tube 1 having an upper end formed with a tapered contact face 10 having a periphery formed with a plurality of positioning holes 101, a rotation tube 2 having a lower end formed with a tapered contact face 20 rotatably mounted on the contact face 10 of the base tube 1 and provided with a protruding limit post 202, a plurality of rotation balls 3 detachably positioned in the positioning holes 101 of the contact face 10 of the base tube 1, and a rotation control member 4 mounted between the contact face 10 of the base tube 1 and the contact face 20 of the rotation tube 2 and formed with at least one limit hole 41, so that when the rotation balls 3 are rotated to a determined position, the limit post 202 of the contact face 20 of the rotation tube 2 is rotated into and limited in the limit hole 41 of the rotation control member 4 so as to limit rotation of the rotation tube 2.

The base tube 1 has a hollow inside to allow passage of a control cord 6. The contact face 10 of the base tube 1 has a central portion formed with a through hole 100.

The rotation tube 2 has a hollow inside to allow passage of the control cord 6. The contact face 20 of the rotation tube 2 has a central portion formed with a locking hole 200. The rotation tube 2 has a periphery formed with a plurality of mounting holes 201 for mounting a plurality of elastic members 30 which are urged on the rotation balls 3 to push the rotation balls 3 toward the positioning holes 101 of the contact face 10 of the base tube 1.

The rotation control member 4 has a central portion formed with a through hole 42 aligning with the through hole 100 of the base tube 1 and the locking hole 200 of the rotation tube 2. The rotation control member 4 has a periphery formed with a plurality of passages 40 to allow passage of the rotation balls 3.

A screw member 5 (such as a hex screw) is extended through the through hole 100 of the base tube 1 and the through hole 42 of the rotation control member 4 and locked in the locking hole 200 of the rotation tube 2 by a locking nut 50 to combine the base tube 1 with the rotation tube 2. The screw member 5 has a hollow inside to allow passage of the control cord 6. The screw member 5 is located in the base tube 1, and the locking nut 50 is located in the rotation tube 2.

In operation, referring to FIGS. 1-7, the shank is used for a large-size umbrella 7. The umbrella 7 comprises a winding mechanism (not shown) for winding the control cord 6 so as to expand the canopy 70 of the umbrella 7.

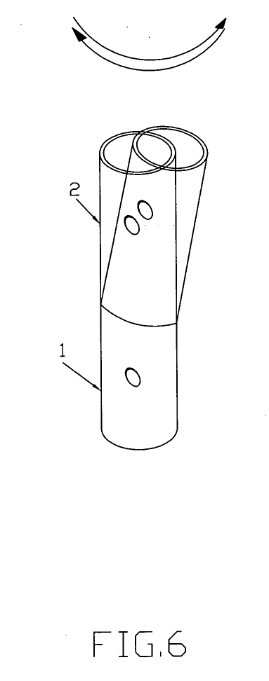

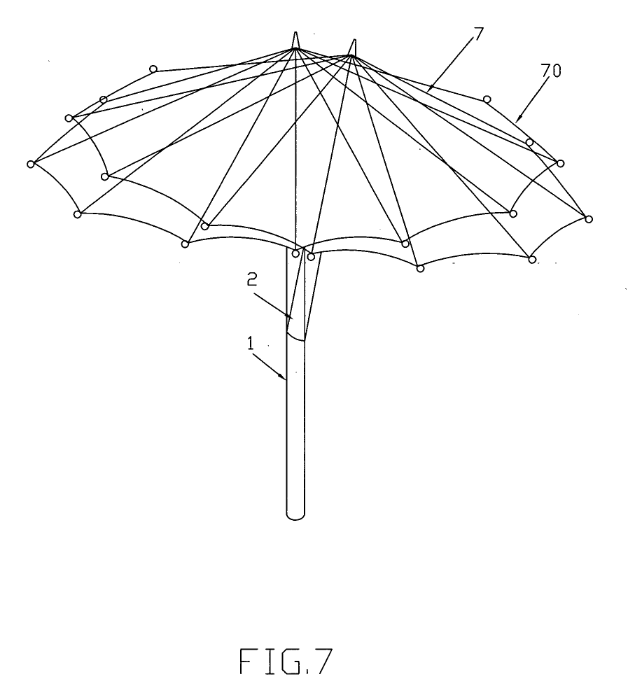

When the rotation tube 2 is rotated on the base tube 1, the contact face 20 of the rotation tube 2 is rotated on the contact face 10 of the base tube 1, so that the rotation tube 2 is rotated relative to the base tube 1 in an inclined manner as shown in FIG. 6 by the tapered design of the contact face 20 of the rotation tube 2 and the contact face 10 of the base tube 1, so as to change and adjust the inclined angle of the canopy 70 of the umbrella 7 according to the incident angle of the solar rays. In such a manner, when the rotation balls 3 are rotated to a determined position, the limit post 202 of the contact face 20 of the rotation tube 2 is rotated into and limited in the limit hole 41 of the rotation control member 4 so as to limit rotation of the rotation tube 2. Thus, the rotation of the rotation tube 2 is limited by the rotation control member 4 so that the rotation tube 2 will not be rotated excessively, thereby preventing the control cord 6 from being tangled.

Accordingly, when the rotation balls 3 are rotated to a determined position, the limit post 202 of the contact face 20 of the rotation tube 2 is rotated into and limited in the limit hole 41 of the rotation control member 4 so as to limit rotation of the rotation tube 2. In addition, the rotation of the rotation tube 2 is limited by the rotation control member 4 so that the rotation tube 2 will not be rotated excessively, thereby preventing the control cord 6 from being tangled. Further, the rotation tube 2 is rotated in a determined direction, so that the shank is operated easily and conveniently, thereby facilitating a user operating the shank. Further, the shank is assembled easily and rapidly, thereby facilitating assembly of the shank and decreasing costs of assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A shank for a large-size umbrella, comprising:
a base tube having an upper end formed with a tapered contact face having a periphery formed with a plurality of positioning holes;
a rotation tube having a lower end formed with a tapered contact face rotatably mounted on the contact face of the base tube and provided with a protruding limit post;
a plurality of rotation balls detachably positioned in the positioning holes of the contact face of the base tube;
a rotation control member mounted between the base tube and the rotation tube and formed with at least one limit hole, wherein when the rotation balls are rotated to a determined position, the limit post of the contact face of the rotation tube is rotated into and limited in the limit hole of the rotation control member.

2. The shank in accordance with claim 1, wherein the rotation tube has a periphery formed with a plurality of mounting holes for mounting a plurality of elastic members which are urged on the rotation balls to push the rotation balls toward the positioning holes of the contact face of the base tube.

3. The shank in accordance with claim 1, wherein the rotation control member has a periphery formed with a plurality of passages to allow passage of the rotation balls.

4. The shank in accordance with claim 1, wherein the rotation control member is mounted between the contact face of the base tube and the contact face of the rotation tube.

5. The shank in accordance with claim 1, wherein the contact face of the base tube has a central portion formed with a through hole, the contact face of the rotation tube has a central portion formed with a locking hole, the rotation control member has a central portion formed with a through hole aligning with the through hole of the base tube and the locking hole of the rotation tube, and the shank further comprises a screw member extended through the through hole of the base tube and the through hole of the rotation control member and locked in the locking hole of the rotation tube by a locking nut to combine the base tube with the rotation tube.

6. The shank in accordance with claim 5, wherein the base tube has a hollow inside to allow passage of a control cord, the rotation tube has a hollow inside to allow passage of the control cord, and the screw member has a hollow inside to allow passage of the control cord.

7. The shank in accordance with claim 5, wherein the screw member is located in the base tube.

8. The shank in accordance with claim 5, wherein the locking nut is located in the rotation tube.

9. The shank in accordance with claim 1, wherein rotation of the rotation tube is limited when the limit post of the contact face of the rotation tube is rotated into and limited in the limit hole of the rotation control member.

10. The shank in accordance with claim 1, wherein rotation of the rotation tube is limited by the rotation control member so that the rotation tube will not be rotated excessively.
